(19) United States
(12) Patent Application Publication
(10) Pub. No.: US 2010/0098988 A1
(43) Pub. Date: Apr. 22, 2010

(54) MEMBRANE ELECTRODE MODULE AND ASSEMBLY METHOD THEREOF

(75) Inventors: Wei-Kai Chang, Taoyuan County (TW); Ming-Chou Tsai, Taoyuan County (TW); Ching-Sen Yang, Taoyuan County (TW); Chiang-Wen Lai, Taoyuan County (TW)

Correspondence Address: QUINTERO LAW OFFICE, PC, 615 Hampton Dr, Suite A202, Venice, CA, 90291, US

(73) Assignee: NAN YA PCB CORP., TAOYUAN COUNTY (TW)

(21) Appl. No.: 12/358,089

(22) Filed: Jan. 22, 2009

(30) Foreign Application Priority Data
Oct. 21, 2008 (TW) TW97140275

(51) Int. Cl. H01M 8/10; H01M 4/04

(52) U.S. Cl. 429/30; 29/623.4

(57) ABSTRACT

A membrane electrode module is provided. The membrane electrode module includes a membrane electrode assembly, a first fixing element and a second fixing element. The membrane electrode assembly includes an exchange-membrane, a first electrode and a second electrode. The exchange-membrane includes a first surface and a second surface. The first electrode is disposed on the first surface. The second electrode is disposed on the second surface. The first fixing element contacts the first surface. The second fixing element contacts the second surface, wherein the first fixing element and the second fixing element are joined to the exchange-membrane via heat-pressing to be fixed to the exchange-membrane.

### CROSS REFERENCE TO RELATED APPLICATIONS

This Application claims priority of Taiwan Patent Application No. 097140275, filed on Oct. 21, 2008, the entirety of which is incorporated by reference herein.

### BACKGROUND OF THE INVENTION

1. Field of the Invention

The present invention relates to a membrane electrode module, and in particular relates to a membrane electrode module that fixes an exchange-membrane via heat-pressing.

2. Description of the Related Art

FIG. 1 shows a conventional membrane electrode module 1 of a fuel cell, comprising a first electrode 10, a second electrode 20 and an exchange-membrane 30. The exchange-membrane 30 is sandwiched between the first electrode 10 and the second electrode 20. The exchange-membrane 30 is fixed on the frame 40 by bolts 2. For the conventional exchange-membrane fixing process, after the exchange-membrane 30 is fixed with the first electrode 10 and the second electrode 20, the exchange-membrane 30 is exposed to air, whereby water contained in the exchange-membrane 30 is lost, and the exchange-membrane 30 curves. In such a case, the bolts 2 cannot tightly fix the curved exchange-membrane 30 to the frame 40, and fuel of the fuel cell thus leaks during electricity generation reactions.

Additionally, the exchange-membrane 30 is fixed on the frame 40 by bolts 2, and therefore gaps are formed between elements (for example, the first electrode 10, the second electrode 20 and the frame 40) of the fuel cell. The water of the exchange-membrane 30 vaporizes during electricity generation reactions, leaking through the gaps, thus leading to cracks in the exchange-membrane 30.

Thus, to prevent the curved exchange-membrane from deteriorating fixing effect, a plurality of exchange-membranes is connected with each other when a plurality of membrane electrode modules is juxtaposed. However, due to increased exchange-membrane material, the cost of the fuel cell is raised.

### BRIEF SUMMARY OF THE INVENTION

A detailed description is given in the following embodiments with reference to the accompanying drawings.

A membrane electrode module is provided. The membrane electrode module comprises a membrane electrode assembly, a first fixing element and a second fixing element. The membrane electrode assembly comprises an exchange-membrane, a first electrode and a second electrode. The exchange-membrane comprises a first surface and a second surface. The first electrode is disposed on the first surface. The second electrode is disposed on the second surface. The first fixing element contacts the first surface. The second fixing element contacts the second surface, wherein the first fixing element and the second fixing element are joined to the exchange-membrane via heat-pressing to be fixed to the exchange-membrane.

The embodiment of the invention realizes heat-pressing of the first fixing element, the second fixing element and the exchange-membrane at a low temperature by choosing and matching proper element materials. During the heat-pressing process, the exchange-membrane does not need to be precisely aligned to the first and second fixing element. Therefore, the first fixing element, the second fixing element and the exchange-membrane can be heat-pressed automatically after the membrane electrode assembly is formed to prevent the exchange-membrane from contacting air. Additionally, the first and second fixing elements can be plastically deformed to fill element gaps around the exchange-membrane to prevent lost of water.

### BRIEF DESCRIPTION OF THE DRAWINGS

The present invention can be more fully understood by reading the subsequent detailed description and examples with references made to the accompanying drawings, wherein:

FIG. 1 shows a conventional membrane electrode module of a fuel cell;

FIG. 2 shows a membrane electrode module of an embodiment of the invention;

FIG. 3 is a top view of the first fixing element; and

FIG. 4 is a top view of the first soft sheet.

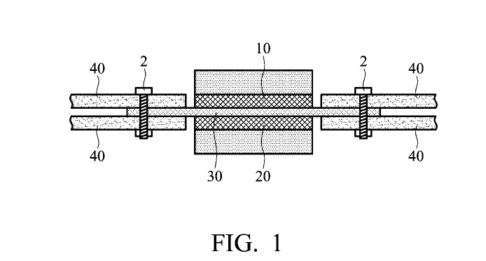

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

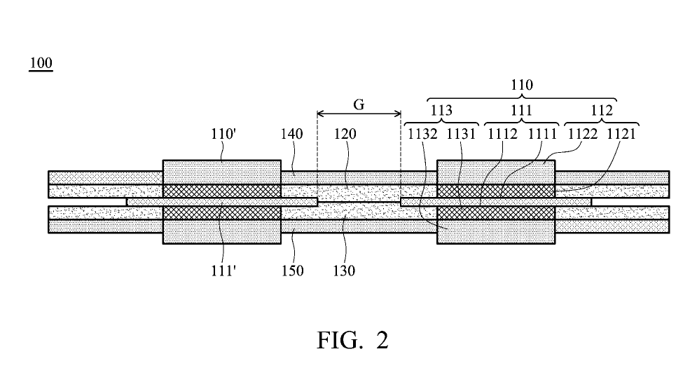

FIG. 2 shows a membrane electrode module 100 of an embodiment of the invention, comprising a membrane electrode assembly 110, a first fixing element 120, a second fixing element 130, a first soft sheet 140 and a second soft sheet 150.

The membrane electrode assembly 110 comprises an exchange-membrane 111, a first electrode 112 and a second electrode 113. The exchange-membrane 111 comprises a first surface 1111 and a second surface 1112. The first electrode 112 is disposed on the first surface 1111. The second electrode 113 is disposed on the second surface 1112. The first electrode 112 comprises a first catalyst layer 1121 and a first gas diffusion layer 1122. The first catalyst layer 1121 is sandwiched between the exchange-membrane 111 and the first gas diffusion layer 1122. The second electrode 113 comprises a second catalyst layer 1131 and a second gas diffusion layer 1132. The second catalyst layer 1131 is sandwiched between the exchange-membrane 111 and the second gas diffusion layer 1132.

The first fixing element 120 contacts the first surface 1111. The second fixing element 130 contacts the second surface 1112. The first soft sheet 140 covers the first fixing element 120. The second soft sheet 150 covers the second fixing element 130. The first soft sheet 140 is connected to the first fixing element 120 by heat-pressing, and the second soft sheet 150 is connected to the second fixing element 130 by heat-pressing. The first fixing element 120 and the second fixing element 130 are heat-pressed with the exchange-membrane 111 to be fixed to the exchange-membrane 111.

The exchange-membrane 111 is a proton exchange-membrane. In the embodiment of the invention, a Nafion proton exchange-membrane is utilized.

The first fixing element 120 and the second fixing element 130 can be made of a thermosetting material, such as pre-preg material or epoxy resin.

The first soft sheet 140 and the second soft sheet 150 can be made of an epoxy resin or glass fiber (for example, FR5).

In the step of the heat-pressing the first soft sheet 140, the second soft sheet 150, the first fixing element 120, the second fixing element 130 and the exchange-membrane 111, a pressing pressure and a pressing temperature are applied to the first fixing element, the second fixing element 130, the first soft sheet 140, the second soft sheet 150 and the exchange-membrane 111. The pressing pressure is between 0˜100 kg/cm². The pressing temperature is between 50˜150° C.

For conventional practice, high temperatures of the heat-pressing process evaporate water in the exchange-membrane, and damage the exchange-membrane. Therefore, a heat-pressing process is not utilized to fix the exchange-membrane for a conventional membrane electrode module.

The embodiment of the invention realizes heat-pressing the first fixing element, the second fixing element and the exchange-membrane at a low temperature by choosing and matching proper element materials. For the heat-pressing process, the exchange-membrane does not need to be precisely aligned to the first and second fixing element. Therefore, the first fixing element, the second fixing element and the exchange-membrane can be heat-pressed automatically after the membrane electrode assembly is formed to prevent the exchange-membrane from contacting air. Additionally, the first and second fixing elements can be plastically deformed to fill element gaps around the exchange-membrane to prevent lost of water.

With reference to FIG. 2, in the embodiment of the invention, the membrane electrode module 100 further comprises a membrane electrode assembly 110′. The membrane electrode assembly 110′ comprises an exchange-membrane 111′. A gap G is formed between the exchange-membrane 111 and the exchange-membrane 111′. Because first and second fixing elements are plastically deformed in heat-pressing to fill the gap G, the exchange-membranes are prevented from being curved, the alignment requirement is less critical, and the exchange-membrane 111 does not need to be connected to the exchange-membrane 111′. Thus, less exchange-membrane material is used, and the cost of the fuel cell is decreased. In the embodiment of the invention, the first fixing element is connected to the second fixing element at the location of gap G.

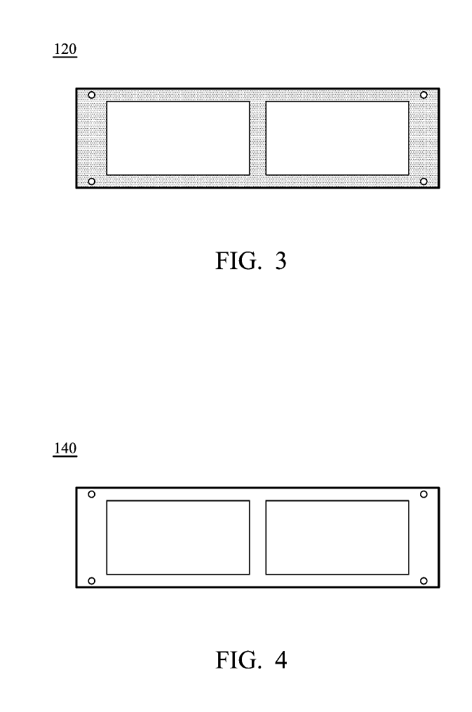

FIG. 3 is a top view of the first fixing element 120. The structure of the second fixing element 130 is the same with that of the first fixing element 120. FIG. 4 is a top view of the first soft sheet 140. The structure of the second first soft sheet 150 is the same with that of the first soft sheet 140. With reference to FIG. 2, in one embodiment of the invention, the compression amount of the first electrode 112 and the second electrode 113 in a subsequent process can be modified by changing thicknesses of the first soft sheet 140 and the second soft sheet 150 to control performance of the membrane electrode module 100.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A membrane electrode module, comprising:
a membrane electrode assembly, comprising:
an exchange-membrane, comprising a first surface and a second surface;
a first electrode, disposed on the first surface; and
a second electrode, disposed on the second surface;
a first fixing element, contacting the first surface; and
a second fixing element, contacting the second surface, wherein the first fixing element and the second fixing element are joined to the exchange-membrane via heat-pressing to be fixed to the exchange-membrane.

2. The membrane electrode module as claimed in claim 1, wherein the first electrode comprises a first catalyst layer and a first gas diffusion layer, the first catalyst layer is sandwiched between the exchange-membrane and the first gas diffusion layer, the second electrode comprises a second catalyst layer and a second gas diffusion layer, and the second catalyst layer is sandwiched between the exchange-membrane and the second gas diffusion layer.

3. The membrane electrode module as claimed in claim 1, wherein the first fixing element and the second fixing element are made of pre-preg material or epoxy resin.

4. The membrane electrode module as claimed in claim 1, further comprising a first soft sheet and a second soft sheet, wherein the first soft sheet covers the first fixing element, and the second soft sheet covers the second fixing element.

5. The membrane electrode module as claimed in claim 4, wherein the first soft sheet and the second soft sheet are made of an epoxy resin or glass fiber.

6. A membrane electrode module, comprising:
a first membrane electrode assembly, comprising a first exchange-membrane;
a second membrane electrode assembly, comprising a second exchange-membrane;
a first fixing element; and
a second fixing element, wherein the first fixing element and the second fixing element are joined to the first exchange-membrane and second exchange-membrane via heat-pressing to be fixed to the first exchange-membrane and second exchange-membrane, and a gap is formed between the first exchange-membrane and second exchange-membrane.

7. The membrane electrode module as claimed in claim 6, wherein the first fixing element and the second fixing element are made of pre-preg material or epoxy resin.

8. The membrane electrode module as claimed in claim 6, further comprising a first soft sheet and a second soft sheet, wherein the first soft sheet covers the first fixing element, and the second soft sheet covers the second fixing element.

9. The membrane electrode module as claimed in claim 8, wherein the first soft sheet and the second soft sheet are made of an epoxy resin or glass fiber.

10. A membrane electrode module assembling method, comprising:
providing a membrane electrode assembly, comprising an exchange-membrane, a first electrode and a second electrode, wherein the exchange-membrane comprises a first surface and a second surface, the first electrode is disposed on the first surface, and the second electrode is disposed on the second surface;
providing a first fixing element and a second fixing element; and
heat-pressing the first fixing element, the second fixing element and the exchange-membrane to be fixed to the exchange-membrane, wherein the fixing element contacts the first surface, and the second fixing element contacts the second surface.

11. The membrane electrode module assembling method as claimed in claim 10, wherein the first electrode comprises a first catalyst layer and a first gas diffusion layer, the first catalyst layer is sandwiched between the exchange-membrane and the first gas diffusion layer, the second electrode comprises a second catalyst layer and a second gas diffusion layer, and the second catalyst layer is sandwiched between the exchange-membrane and the second gas diffusion layer.

12. The membrane electrode module assembling method as claimed in claim 10, wherein the first fixing element and the second fixing element are made of a thermosetting material.

13. The membrane electrode module assembling method as claimed in claim 10, wherein the first fixing element and the second fixing element are made of pre-preg material or epoxy resin.

14. The membrane electrode module assembling method as claimed in claim 10, further comprising:
providing a first soft sheet and a second soft sheet; and
covering the first soft sheet over the first fixing element and covering the second soft sheet over the second fixing element, wherein in the step of heat-pressing the first fixing element, the second fixing element and the exchange-membrane, the first soft sheet is heat-pressed with the first fixing element, and the second soft sheet is heat-pressed with the second fixing element.

15. The membrane electrode module assembling method as claimed in claim 14, wherein the first soft sheet and the second soft sheet are made of an epoxy resin or glass fiber.

16. The membrane electrode module assembling method as claimed in claim 14, wherein, in the step of heat-pressing, the first fixing element, the second fixing element and the exchange-membrane, a pressing pressure is applied to the first fixing element, a second fixing element, the first soft sheet, the second soft sheet and the exchange-membrane, and the pressing pressure is between 0˜100 kg/cm².

17. The membrane electrode module assembling method as claimed in claim 14, wherein in the step of heat-pressing the first fixing element, the second fixing element and the exchange-membrane, a pressing temperature is applied to the first fixing element, a second fixing element, the first soft sheet, the second soft sheet and the exchange-membrane, and the pressing temperature is between 50˜150° C.

18. The membrane electrode module assembling method as claimed in claim 14, further comprising changing thicknesses of the first soft sheet and the second soft sheet to modify compression amount of the first electrode and the second electrode in a subsequent process.

19. The membrane electrode module assembling method as claimed in claim 10, wherein in the step of heat-pressing the first fixing element, the second fixing element and the exchange-membrane, a pressing pressure is applied to the first fixing element, a second fixing element and the exchange-membrane, and the pressing pressure is between 0˜100 kg/cm².

20. The membrane electrode module assembling method as claimed in claim 10, wherein in the step of heat-pressing the first fixing element, the second fixing element and the exchange-membrane, a pressing temperature is applied to the first fixing element, a second fixing element and the exchange-membrane, and the pressing temperature is between 50˜150° C.
